(19) United States
(12) Patent Application Publication
(10) Pub. No.: US 2026/0081435 A1
(43) Pub. Date: Mar. 19, 2026

(54) SENSING AND CHARGING SYSTEMS AND METHODS

(71) Applicant: T-Mobile Innovations LLC, Overland Park, KS (US)

(72) Inventors: Jean TRAKINAT, Valrico, FL (US); Mark YOUNGE, Golden, CO (US)

(21) Appl. No.: 18/887,355

(22) Filed: Sep. 17, 2024

(51) Int. Cl. H02J 7/00; H02J 50/80

(52) U.S. Cl. CPC H02J 7/42; H02J 7/80; H02J 50/80

(57) ABSTRACT

Methods and systems are provided for utilizing a sensing charger to monitor input data and to charge a wireless device. Through the monitoring, risks can be identified based on the monitored input data and analysis. The monitored input data and analysis results can be transmitted to an external device such as a sensor monitoring services or a wireless device being charged.

### TECHNICAL BACKGROUND

As wireless networks evolve and grow, applications have evolved for sensing conditions within the home or other buildings and leveraging the wireless networks to process sensed conditions. Sensors may be or include, for example, internet of things (IoT) devices, artificial intelligence of things (AIoT) devices, or reduced capability (RedCap) devices. Sensors have evolved for sensing power surges, smoke, carbon monoxide, water leaks, noise, break-ins, and other potentially troublesome conditions.

Existing sensors may be wired or wirelessly connected with external systems or user mobile devices such as, for example, enhanced mobile broadband (eMBB) devices. Further, sensors may report data, such as break-ins, over the wired or wireless connection to an external monitoring service, such as a security provider. Further solutions are needed for enhancing the versatility and functionality of existing sensors.

### OVERVIEW

Exemplary embodiments provided herein include a wireless device charger and sensing device incorporating one or more sensors for sensing one or more conditions. In some embodiments, a method includes monitoring power data using the sensing charger having an incorporated sensor and charging a wireless device simultaneously with the monitoring of the power data. The method further includes delivering the monitored power data from the sensing charger to the wireless device.

A further aspect includes a device incorporating both charging and sensing functions. The device includes a plug insertable in an electrical outlet and an interface facilitating a connection with a wireless device. The device additionally includes charging components operable to charge the wireless device connected through the interface with the plug inserted into the electrical outlet. The device further includes a power sensor configured to monitor power data from the electrical outlet with the plug inserted into the electrical outlet and a processor detecting and processing output from the power sensor and triggering delivery of the processed output to an external device. In some aspects, the external device may be the wireless device and in other aspects, the external device may be a monitoring system.

Further aspects include a method comprising monitoring power data using a sensing charger and charging a wireless device simultaneously with the monitoring of the power data using the sensing charger. The method further includes delivering the monitored power data from the sensing charger over a network to an external monitoring system.

### BRIEF DESCRIPTION OF THE DRAWINGS

FIG. 1 depicts an exemplary environment for providing a sensing charger in accordance with an embodiment.

FIG. 2 depicts an exemplary sensing charger in accordance with an embodiment.

FIG. 3 depicts an exemplary wireless device in accordance with an embodiment.

FIG. 4 depicts an exemplary sensor monitoring system in accordance with an embodiment.

FIG. 5 depicts an exemplary method for operating a sensing charger in accordance with an embodiment.

FIG. 6 depicts a further method for utilizing a sensing charger in accordance with an embodiment.

### DETAILED DESCRIPTION

Embodiments provided herein include methods, systems and devices for providing charging and sensing services originating from a single device. The single device may be a sensing charger capable of sensing power provided to an electrical outlet while plugged into the electrical outlet. Chronic or intermittent quality of service issues can be difficult to diagnose and correct. The sensing charger is operable to collect and record power supply information for further analysis.

Embodiments provided herein integrate sensors into a wireless device charger. The sensors may be configured to monitor environmental conditions and utility services (e.g. power, water, gas) and to inform a building resident or a third party (e.g. property manager, utility companies) of chronic problems or inconsistent quality of service. The sensing charger may relay the data sensed to the charging wireless device via a communication interface, which may include for example, a universal system bus (USB), Bluetooth, Wifi, nearfield communications (NFC) etc. Further, the collected data may be stored by the wireless device and/or transmitted over a cellular network by the wireless device to a server that collects and processes the data to provide an information service for intended recipients.

Examples of conditions detected using the sensing charger may include, for example, periodic power failures, dropouts, spikes, as well as identification of resistive, capacitive, and inductive loading for power consumption analysis. These conditions may require analysis and correction. Further detectable conditions could include water leaks, noise, smoke, temperature, carbon monoxide, movement (break-ins or theft). In some embodiments, the sensing charger acts as a bridge or router for other sensors (e.g. water meter, thermostat, etc.) within range to likewise connect and transfer their data over the wireless network. The device could contain, or access, an artificial intelligence (AI) engine in the user equipment (UE) or wireless device or in the network to analyze and report the sensed conditions above.

The sensing charger disclosed herein has access to power information when it is plugged into the wall. Accordingly, the sensing charger, using a sensor monitors the power supply data. The sensing charger may deliver the power data to a wireless device while the wireless device is charging. Further, the sensing charger may deliver the power supply data to a dedicated service accessible over the Internet for monitoring power glitches. The data may be delivered periodically in a configurable manner. Additionally, the dedicated service may collect data from multiple properties and consolidate and deliver data to property owners or managers.

The sensing charger may also include additional sensors capable of monitoring conditions such as temperature or humidity inside of a building. Further, the sensing charger may have WiFi, Bluetooth, Bluetooth low energy (BLE), and/or other networking capability to enable interaction with additional devices that sense and/or regulate the conditions. Alternatively or additionally, the sensing charger may include a powerline adapter or modem that connects computers and devices to the Internet via pre-existing electricity lines in a building. Such a power line adapter operates by using existing wiring instead of requiring new cables, making it easier and faster to connect multiple pieces of equipment in homes and buildings. The powerline adapter can also provide a secure connection between two or more computers in order to allow sharing of data. The powerline adapter works by taking electricity from an electrical outlet and transforming it into a radio frequency signal that is then transmitted by the powerline adapter over existing wiring. This allows use of the same outlet as both an input for power and an output for data transmission. The signal from the outlet may then be broadcast, for example, via WiFi, or using an Ethernet cable.

Further, the sensing charger may utilize the wireless device, such as a mobile phone, as an Internet communication device to send data. The data may include power data as the sensing charger retrieves power data while it is plugged into an electrical outlet. The sensing charger may further monitor temperature data using an internal sensor or through communication with a thermostat. Similarly, the sensing charger may detect water leaks by communicating with a sensor at a water meter, detect gas leaks by communicating with a sensor at a gas meter, or detect appliance status by communicating with sensors at sump pumps, refrigerators, air conditioners, etc. The sensing charger may further incorporate or communicate with noise detectors, cameras, or surveillance devices, which may be coupled over a local area network (LAN) of IoT devices. The sensing charger may further sense the health of various connected sensors. For example, the sensing charger may detect that a battery or a sensor is failing and needs to be replaced.

An exemplary environment described herein includes a sensing charger, at least one end user wireless device and at least an access node (or base station), such as a next generation NodeB (gNodeB or gNB). In addition to the systems and methods described herein, the operations described herein may be implemented as computer-readable instructions or methods and processing nodes on the network for executing the instructions or methods.

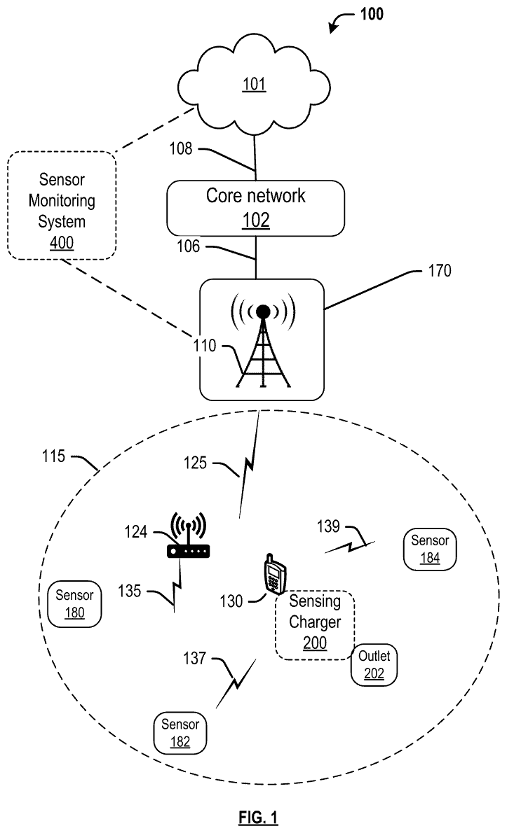

FIG. 1 depicts an exemplary environment 100 for implementing a sensing charger 200 in a wireless network. In the displayed environment 100, the sensing charger 200 operates to monitor a power supply when the sensing charger 200 is plugged into an electrical outlet 202. Further, the sensing charger 200 operates so as to communicate with multiple wireless devices 130 within a coverage area 115. These wireless devices may be, for example, eMBB devices, IoT devices, home internet (HINT) devices or any other type of wireless device capable of connecting with a wireless network. The sensing chargers 200 may be plugged into electrical outlets 202 in order to charge the wireless device 130. Further, sensors 180, 182, and 184 operate within the coverage area 115 and may be capable of communicating with the sensing charger 200 through a communication interface which may be a wired or wireless interface. For example, sensor 182 may communicate with sensing charger 200 over a communication link 137 and sensor 184 may communicate with the sensing charger of a communication link 139.

Environment 100 comprises a communication network 101, core network 102, and a radio access network (RAN) 170 including at least an access node 110. Wireless device 130 and further a WiFi access point 124 may communicate with the access node 110 over wireless link 125 deployed by the access node 110. Additionally, the wireless devices 130 may access the communication network 101 through the router or wireless access point 124 using a communication link 135. Although not shown, the wireless device 130 may further access the communication network 101 through an Internet service provider (ISP).

The exemplary operating environment 100 may further include a sensor monitoring system 400 which may be operated by a sensor monitoring service in order to recognize irregularities in sensed data and report the irregularities. The sensor monitoring system 400 may be accessible over the communication network 101 and can be connected to the communication network 101 in any known manner. Additionally, components not shown may include, for example, gateway node(s) controller nodes, and additional access nodes.

For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

The exemplary operating environment 100 may include the sensor monitoring system 400, which is illustrated as operating between the communication network 101 and the RAN 170. Thus, the sensor monitoring system 400 may be distributed or may be an entirely discrete system operating in conjunction with the communication network 101 and/or the RAN 170 and/or the wireless device 130.

The sensor monitoring system 400 receives information pertaining to sensed data from the wireless device 130, which receives the information from the sensing charger 200 while the sensing charger 200 charges the wireless device 130. As a further alternative, the sensor monitoring system 400 may receive sensed data over a wired connection when the sensing charger 200 is plugged into the outlet 202. The collected data may be collected from the power supply connected to the outlet 202 by the sensing charger 200. Additionally, the sensing charger 200 may collect the data using internal sensors, which will be further described below. As a further alternative, the collected data may be collected from the sensors 180, 182, 184 by the sensing charger 200 using a wireless or wired connection.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Wireless devices 130 may be any device, system, combination of devices, or other such communication platform capable of communicating wirelessly with access node 110 using one or more frequency bands deployed therefrom. Wireless device 130 may be, for example, eMBB devices. The wireless devices 130 may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device, a laptop, a tablet, as well as other types of devices or systems that can exchange audio or data via access node 110.

Sensors 180, 182, 184 may include IoT devices that build a network of physical objects or things that are embedded with sensors, software, and other technologies for the purpose of connecting and exchanging data with other devices and systems over the Internet or communication network 101. Cellular IoT connects physical things, such as sensors to the Internet by having them utilize the same mobile networks as wireless devices. IoT technology can be utilized to equip the “smart home”, including devices such as lighting fixtures, thermostats, home security systems, noise detectors and cameras, sensors at water meters, refrigerator compressors, gas meters, or sump pumps. The devices can often be controlled using smartphones, such as wireless device 130. Further, businesses, such as utility companies utilize industrial wireless sensors for reporting usage parameters and performing other necessary tasks. With either smart home or business applications, IoT devices can be controlled by other wireless devices 130 which may be smart phones, laptop computers, tablets, etc. Further, the sensors 180, 182, 184 may be positioned within a building within the coverage area 115.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or protocols associated with other generations or types of wireless communication technologies. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or protocols associated with other generations or types of wired communication technologies. Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

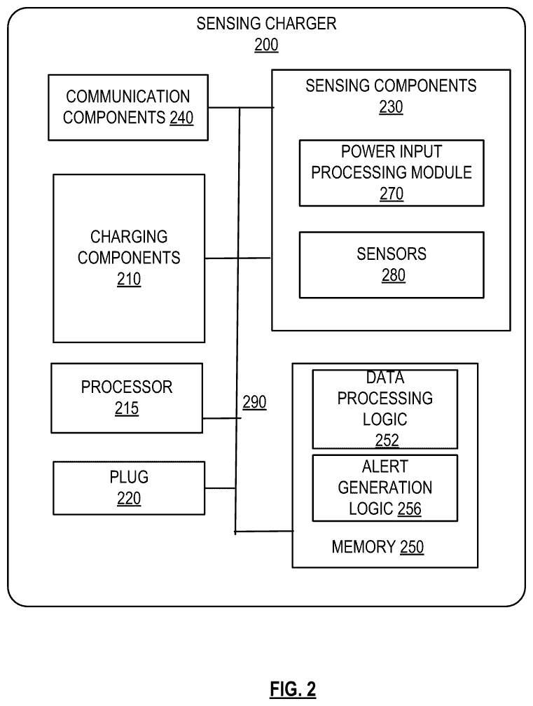

FIG. 2 illustrates a sensing charger 200 in accordance with embodiments described herein. The components described herein are merely exemplary as many different configurations for the sensing charger 200 may be implemented. The sensing charger 200 may be configured to perform the methods and operations disclosed herein to charge a wireless device 130, sense environmental conditions, and transmit collected data to the wireless device 130 and other external devices 400. In the disclosed embodiments, the sensing charger 200 may be inserted in an electrical outlet 202 and may sense power parameters while inserted in the electrical outlet. Further, the sensing charger 200 may provide sensed data to the wireless device 130 when charging the wireless device 130.

The sensing charger 200 may include charging components 210, a processor 215, a plug 220, sensing components 230, communication components 240, and a memory 250. The components may be connected, for example, by a system bus 290. A larger or smaller number of components may alternatively be included. While the sensing charger is described as a single device, it may have multiple parts. For example, the plug 220 connecting with the wall outlet may be separate from sensing intelligence or components 230 located in a separate connectable section or within a power cord of the sensing charger 200.

The sensing charger 200 is configured to perform at least one sensing function, which includes monitoring power data while plugged into the electrical outlet 202. Further, the sensing charger 200 is configured to charge the wireless device 130 and may perform charging simultaneously with the monitoring of the power data through the electrical outlet 202. Further, the sensing charger 200 is configured to deliver the monitored power data to the wireless device 130 or other external components such as the sensor monitoring system 400.

The charging components 210 may include any known components for charging a wireless device 130. For example, the charging components may include a transformer, such as a step down transformer for receiving AC power. A bridge rectifier circuit and a filter may also be included. The charging components 210 may include in interface for connection with a wireless device 130. The interface may include a port allowing insertion of a cable connected to the wireless device. For example, the interface may include a Universal Serial Bus (USB) port, C port, or other type of charging port. The charging components 210 may further include a wireless charging interface. Thus, in some embodiments, charging may occur by inductive couple and a charging pad and inductive coils may be included. It should be noted that the charging components 210 can also serve as communication components 240. For example, power input processing module 270 or processor 215 can deliver processed output to the wireless device 130 using the wireless interface or cable connected to the ports described above.

The sensing components 230 may include, for example, a power input processing module 270, and additional sensors 280. The power input processing module 270 may include further components or circuitry, such as for example, an analog to digital converter (ADC) to detect waveforms when the sensing charger 200 is plugged into the electrical outlet 202. The sensing components 230 monitor incoming waveforms and can examine a phase relationships to identify the risk for periodic power failures, dropouts, spikes, etc. In some examples, a voltage waveform may include the voltage shape over time, with voltage on the vertical axis and time on the horizontal axis. Waveforms may be smooth, square, rectangular, sawtooth, or triangular. The shape of a waveform can reveal a lot about a signal, such as changes in voltage. For example, a change in the height of the waveform indicates a change in voltage.

Additional information about waveforms may include frequency, period, classification and distortion. The frequency of the waveform is number of time a waveform's cycle repeats per second, measured in hertz (Hz). The period is the amount of time it takes for a waveform to complete one cycle. Additionally, waveforms may be classified by the timescales, magnitudes, and averaging windows used to calculate them and waveforms can be distorted by network impedance and loads that draw distorted current waveforms.

The power input processing module 270 may include components such as capacitors, resistors, and amplifiers that sense electrical activity when the sensing charger 200 is plugged into the electrical outlet 202. The power input processing module 270 may include firmware or hardware components that filter the frequency response of the sensing components 230 to reflect a high signal to noise ratio (SNR). Further, the power input processing module 270 may be utilized to identify transients in waveform data collected, as the transients may be indicative of irregularities in the power supply and the increased risk. Sensing components 230 may further include additional sensors 280 for sensing environmental conditions in proximity to the electrical outlet 202. The sensors 280 may include any type of sensors including, but not limited to, temperature sensors, moisture sensors, noise sensors, motion sensors, smoke sensors, or carbon monoxide sensors.

The processor 215 may be configured to process sensed data from the sensors 280 and optionally store the sensed data in the memory 250 and cause the sensed data to be transmitted through communication components 240 to external devices 130 and 400. Further, the processor 215 may execute logical modules stored in memory 250 to assess risk related to sensor data.

The communication components 240 may include communication circuitry and may be configured to enable the sensing components 230 and/or the processor 215 to communicate with other components, nodes, or devices in the wireless network. The communication components 240 may include WiFi communication components, Bluetooth components, other wireless communication components and/or wired communication components. For example, the communication components 240 may include a power line adaptor or modem The powerline adaptor or modem can connect devices to the communication network 101 by using pre-existing electrical wiring in a building. The powerline adaptor or modem can utilize an ethernet cable to obtain a faster connection than WiFi and can further facilitate transmission of data from the sensing charger 200 to external devices over the communication network 101. The external devices may include, for example, the sensor monitoring system 400. In some instances, the communication components 230 may enable the sensing charger 200 to acts a bridge or router for other sensors or sensing chargers within range to connect and transfer their data over the wireless network.

The plug 220 may be an alternating current (AC) power plug for connection to the outlet 202 in order to supply the sensing charger 200 with electrical power. The plug 220 may be attached to the sensing charger 200 by a cable or may be integral with the sensing charger. Inserting the plug 220 into the electrical outlet 202 allows the sensing charger 200 to draw power from the power supply to the premises and provide power to the charging components 210.

The memory 250 may be included to store collected data and may be or include a RAM, ROM, disk drive, a flash drive, a memory, or other storage device configured to store data and/or computer readable instructions or codes (e.g., software). The computer executable instructions or codes may be accessed and executed by the processor 215 or power input processing module 270 to perform various methods disclosed herein. For example, the memory 250 may store data processing logic 252 and alert generation logic 256. The data processing logic 252 may operate on the sensed data to identify outliers and risks and the alert generation logic 256 may cause an alert to be generated from the sensing charger 200. Further, the memory may store software including computer programs, firmware, or other form of machine-readable instructions, including an operating system, utilities, drivers, network interfaces, applications, or other type of software. For example, software stored in storage device 250 may include a module for performing various operations described herein.

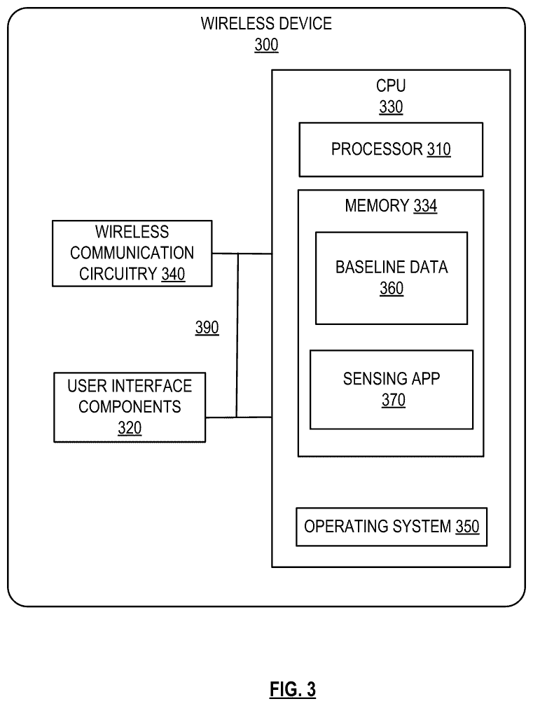

FIG. 3 depicts a wireless device 300 in accordance with disclosed embodiments. The wireless device 300 may correspond to, or be a representation of the wireless devices 130 shown in FIG. 1. As illustrated, the wireless device 300 includes wireless communication circuitry 340, user interface components 320, a central processing unit (CPU) 330, processor 310, memory 334, and operating system 350. Components may be connected, for example, by a bus 390. These components are merely exemplary and the wireless device 300 may include a larger or smaller number of components capable of performing the functions described herein. For example, wireless devices such as smartphones may have multiple microprocessors and microcontrollers. A microprocessor may have a bus to communicate with memory on separate chips and buses to communicate with the rest of the equipment. Alternatively or additionally, the wireless device 300 may include a System On a Chip (SoC).

The memory 334 may store, for example, baseline data 360 and a sensing mobile application 370. When executed by the processor 310, the sensing mobile application 370 interacts with the baseline data 360 to perform various methods for operating on the sensed data from the sensing charger 200. In the illustrated embodiment, the baseline data 360 are located within the wireless device 300. However, in additional embodiments, the baseline data is additionally or alternatively stored in the sensing charger device 200 or at the sensor monitoring system 400.

Thus, in embodiments provided herein, the sensor monitoring application 370 operates in conjunction with the processor 310 to perform a method to detect deviations of sensed data from the baseline data 360. In embodiments provided herein, the sensor monitoring application 370 is capable of generating alerts based on the comparison. The alerts may be displayed on the user interface components 320. As a further alternative, the wireless device 300 may communicate these deviations to the sensor monitoring system 400 for alert generation.

The wireless communication circuitry 340 may include circuit elements configured to generate wireless signals (e.g., one or more antennas) as well as interface elements configured, for example, to translate control signals from the CPU 330 into data signals for wireless output. The CPU 330 may be configured to receive, interpret, and/or respond to signals received via the wireless communication circuitry 340. The CPU 330 may be configured to receive a network command (e.g., from an access node 110) to perform other specified functions. The user interface components 320 may be or include any components enabling a user to interact with the wireless device 300, including tools for managing sensing application 370.

Thus, the wireless device 300 includes the processor 310 executing the sensing application 370 to provide a user interface alerting the mobile device user. The processor 310 executes the sensing mobile application 370 to provide notifications through the user interface of the wireless device 300.

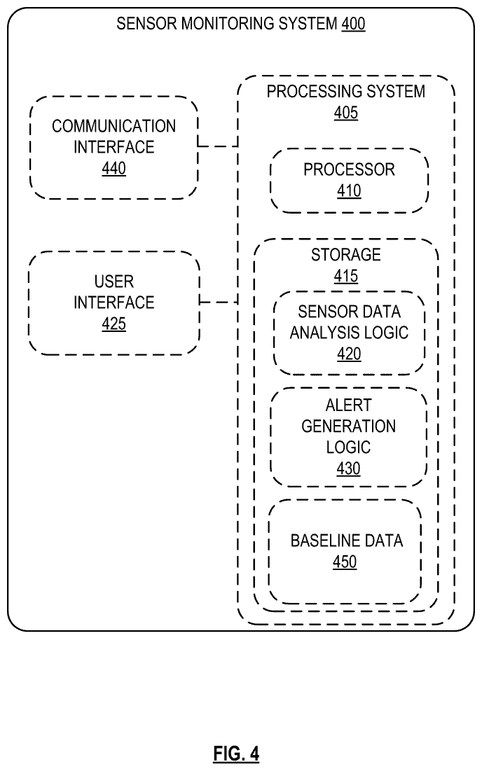

FIG. 4 illustrates an exemplary sensor monitoring system 400 in accordance with embodiments disclosed herein. The sensor monitoring system 400 may be configured for collecting data transmitted by the wireless device 130 to the communication network 101 or by sensing charger 200 to the wireless communication network 101. To perform processes for sensor monitoring, the sensor monitoring system 400 may utilize a processing system 405. Processing system 405 may include a processor 410 and a storage device 415. Storage device 415 may include a RAM, ROM, disk drive, a flash drive, a memory, or other storage device configured to store data and/or computer readable instructions or codes (e.g., software). The computer executable instructions or codes may be accessed and executed by processor 410 to perform various methods disclosed herein.

Software stored in storage device 415 may include computer programs, firmware, or other form of machine-readable instructions, including an operating system, utilities, drivers, network interfaces, applications, or other type of software. For example, software stored in storage device 415 may include a module for performing various operations described herein. For example, in some embodiments, the sensor monitoring system may include baseline data 450 for comparison with collected data. Sensor data analysis logic 420 may include instructions for performing a comparison between the baseline data 450 and data collected by the sensing charger 200. Further, alert generation logic 430 may be included to generate alerts when the comparison between the baseline data 450 and collected data reveals that the collected data diverges significantly or meets particular thresholds defined in the baseline data 450.

Processor 410 may be a microprocessor and may include hardware circuitry and/or embedded codes configured to retrieve and execute software stored in storage device 415. The sensor monitoring system 400 further includes a communication interface 440 and a user interface 425. For example, the sensor monitoring system 400 receives relevant parameters from the wireless devices 130, 300 or directly from the sensing charger 200.

Communication interface 440 may include hardware components, such as network communication ports, devices, routers, wires, antenna, transceivers, etc. User interface 425 may be configured to allow a user to provide input to the sensor monitoring system 400 and receive data or information from access nodes 110 and/or wireless device 130. User interface 425 may include hardware components, such as touch screens, buttons, displays, speakers, etc. The sensor monitoring system 400 may further include other components such as a power management unit, a control interface unit, etc.

The location of the sensor monitoring system 400 may depend upon the network architecture. As set forth above, the sensor monitoring system 400 may be located in a separate processing node, in the RAN 170, in multiple locations, or may be an entirely discrete component. Further, although shown as a single integrated system, the functions of storing baseline data, data analysis, and alert generation may be separated and disposed in separate locations.

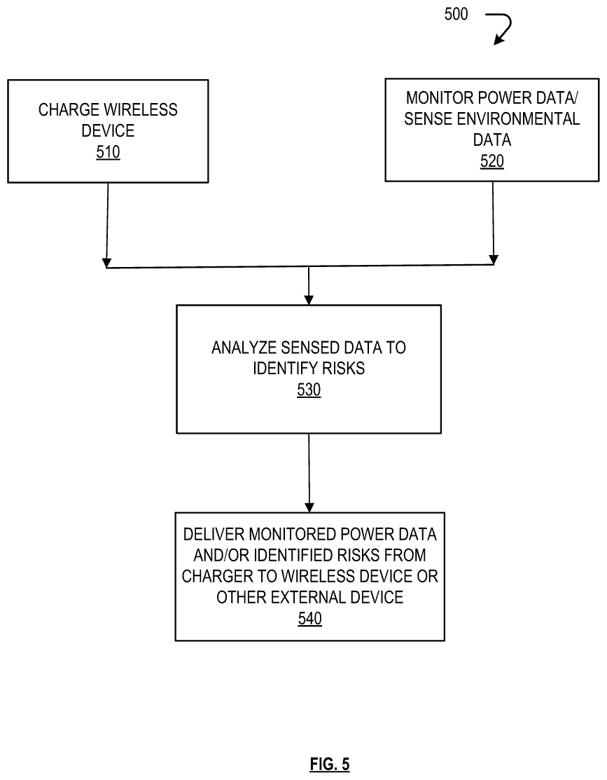

FIG. 5 illustrates an exemplary method 500 for providing sensing services in combination with charging services from a sensing charger 200. Method 500 may be performed by any components discussed herein. For discussion purposes, as an example, method 500 is described as being performed by the sensing charger 200.

Method 500 starts in steps 510 and 520, which may occur simultaneously. In step 510, the sensing charger 200 is implemented to charge the wireless device 300. In order to charge the wireless device 300, the sensing charger 200 is plugged into the outlet 202 and the wireless device 300 is either physically connected to the sensing charger 200 utilizing a cable or is placed in proximity to the sensing charger 200 and is charged wirelessly. In step 520, the sensing charger 200 monitors power data. In order to monitor the power data in step 520, the sensing charger 200 must be connected to the electrical outlet 202 using its plug 220. When plugged into the electrical outlet 202, the sensing charger 200 is capable of monitoring power data using its sensing components described above.

In step 530, the sensing charger 200 may utilize the processor 215 to identify risks and irregularities in sensed data. For example, with respect to power data, the sensing charger 200 may identify spikes, power failures, dropouts, etc. by comparing monitored data with baseline data.

Finally, in step 540, the processor 215 of the sensing charger 200 may cause the monitored power data to be delivered to an external device, such as the wireless device 300 or the sensor monitoring system 400. For example, when the sensing charger 200 is wirelessly connected or connected by a charging cable to the wireless device 300, the sensing charger 200 may deliver the monitored power data to the wireless device 300. Further, as described above, the sensing charger 200 may include communication components including a power line adaptor or a power line modem. In this instance, the sensing charger 200 may transmit its sensed data over existing wiring to the communication network 101 and ultimately the sensor monitoring system 400. While in some instances, the sensed data is limited to power supply data, in other instances multiple types of environmental data may be included based on the sensors contained in the sensing charger 200 or the sensors 180, 182, 184 that communicate with the sensing charger 200. In some embodiments, the sensing charger 200 may deliver all sensed data. However, in other embodiments, the sensing charger 200 may deliver only identified risks or irregularities identified in step 530.

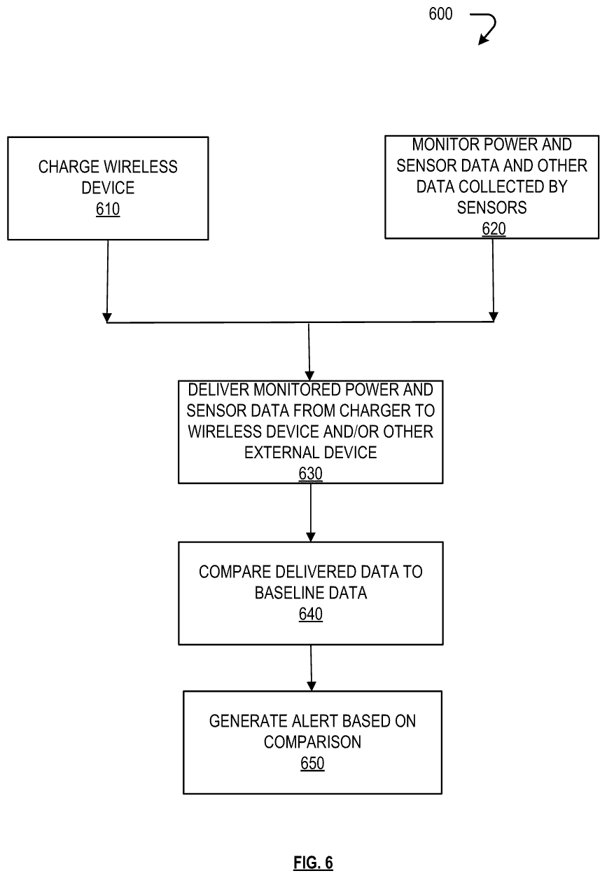

FIG. 6 depicts a further exemplary method 600 for providing sensing services in combination with charging services by a sensing charger 200. Method 600 may be performed by any components discussed herein. For discussion purposes, as an example, method 600 is described as being performed by the sensing charger 200 in combination with external devices, such as wireless device 300 or sensor monitoring system 400.

Method 600 starts in steps 610 and 620, which may occur simultaneously. In step 610, the sensing charger 200 is implemented to charge the wireless device 300. In order to charge the wireless device 300, the sensing charger 200 is plugged into the outlet 202 and the wireless device 300 is either physically connected to the sensing charger 200 utilizing a cable or is placed in proximity to the sensing charger 200 and is charged wirelessly.

In step 620, the sensing charger 200 monitors power data and senses other data and/or collects sensed data from proximal sensors 180, 182, and 184. In order to monitor the power data in step 520, the sensing charger 200 must be connected to the electrical outlet 202 using its plug 220. When plugged into the electrical outlet 202, the sensing charger 200 is capable of monitoring power data using its sensing components described above. The monitored power data may include power irregularities. Further, the sensing charger 200 is capable of monitoring environmental conditions monitored by its internal sensors 280.

In step 630, the sensing charger 200 may cause the monitored power data and additional sensed environmental data to be delivered to an external device, such as the wireless device 300 or the sensor monitoring system 400. For example, when the sensing charger is wirelessly connected or connected by a charging cable to the wireless device 300, the sensing charger 200 may deliver the monitored power data to the wireless device 300. Further, as described above, the sensing charger 200 may include communication components including a power line adaptor or a power line modem. In this instance, the sensing charger 200 may transmit its sensed data over existing wiring to the communication network 101 and ultimately the sensor monitoring system 400. While in some instances, the sensed data is limited to power supply data, in other instances multiple types of environmental data may be included based on the sensors contained in the sensing charger 200 or the sensors 180, 182, 184 that communicate with the sensing charger 200. The additional environmental conditions may include one or more of temperature, humidity, water usage, smoke, carbon monoxide, noise level, and appliance usage.

In step 640, the external device compares the received data to baseline data. For example, the wireless device 300 may utilize the sensing mobile application 370 to compare the sensed data to the baseline data. The sensor monitoring system 400 may utilize the sensor data analysis logic 420 to compare delivered data to baseline data.

In step 650, the external device may find that predetermined deviations exist from the baseline data. For example, the baseline data may include a set of thresholds. When the sensed data meets the stored thresholds, the external device 300 or 400 may generate an alert based on the comparison.

In some embodiments, methods 500 and 600 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 500 and 600 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
monitoring power data using a sensing charger;
charging a wireless device simultaneously with the monitoring of the power data using the sensing charger; and
delivering the monitored power data from the sensing charger to the wireless device.

2. The method of claim 1, further comprising delivering the monitored power data over a network to another external device.

3. The method of claim 1, further comprising performing analysis of the power data and identifying risks from the monitored power data based on irregularities of the monitored power data.

4. The method of claim 1, further comprising sensing additional conditions with an additional sensor incorporated in the sensing charger.

5. The method of claim 4, wherein the additional conditions include at least one of temperature, humidity, water usage, smoke, carbon monoxide, noise level, and appliance usage.

6. The method of claim 4, further comprising monitoring multiple additional conditions utilizing more than one additional sensor.

7. The method of claim 4, further comprising delivering additional data pertaining to the additional conditions over a network to an external device or external system.

8. The method of claim 4, further comprising delivering additional data pertaining to the additional conditions to the wireless device.

9. The method of claim 8, further comprising delivering the additional data pertaining to the additional sensed conditions to a mobile application installed on the wireless device.

10. A device comprising:
a plug insertable in an electrical outlet;
an interface facilitating a connection with a wireless device;
charging components operable to charge the wireless device connected through the interface with the plug inserted into the electrical outlet;
a power input processing module configured to monitor power data from the electrical outlet with the plug inserted into the electrical outlet; and
a processor detecting and processing output from the power input processing module and triggering delivery of the processed output to an external device.

11. The device of claim 10, wherein the interface comprises a port allowing insertion of a cable connected to the wireless device.

12. The device of claim 10, wherein the interface comprises a wireless charging interface.

13. The device of claim 10, further comprising an additional sensor operable to sense environmental conditions in proximity to the electrical outlet.

14. The device of claim 10, further comprising a communication interface delivering the processed output from the processor to the wireless device.

15. The device of claim 10, wherein the external device is the wireless device or another remotely located device different from the wireless device.

16. A method comprising:
monitoring power data using a sensing charger;
charging a wireless device simultaneously with the monitoring of the power data using the sensing charger; and
delivering the monitored power data from the sensing charger over a network to an external device different from the wireless device.

17. The method of claim 16, further comprising sensing additional conditions with at least one sensor incorporated in the sensing charger.

18. The method of claim 17, wherein the additional conditions include at least one of temperature, humidity, water usage, smoke, carbon monoxide, noise level, and appliance usage.

19. The method of claim 18, further comprising monitoring multiple additional conditions utilizing one or more additional sensors that are linked to the sensing charger via at least one communication link.

20. The method of claim 19, further comprising routing sensor data from the one or more additional sensors via the sensing charger over the network to the external device different from the wireless device.
